(19) United States
(12) Patent Application Publication
(10) Pub. No.: US 2011/0197725 A1
(43) Pub. Date: Aug. 18, 2011

(54) PUNCHING UNIT

(75) Inventors: Kazuo NISHIMURA, Kaga (JP); Toshiyuki Majima, Kaga (JP); Megumi Ichikawa, Kaga (JP)

(73) Assignee: DAIDO KOGYO CO., LTD., Kaga (JP)

(21) Appl. No.: 13/023,977

(22) Filed: Feb. 9, 2011

(30) Foreign Application Priority Data
Feb. 12, 2010 (JP) 2010-029421

(51) Int. Cl. B26F 1/38; B26D 5/16; B26F 1/00

(52) U.S. Cl. 83/13; 83/627; 83/635; 83/628; 83/618

(57) ABSTRACT

There is provided a punching unit having a structure permitting to reduce a force required for punching, permitting to lessen parts and permitting to punch holes through a member to be perforated at arbitrary positions thereof. The punching unit has a holder that holds one or plurality of sets of punches and dies. The holder is movable in an array direction in which a plurality of holes to be perforated through the member is arrayed. An eccentric cam is disposed above the holder in parallel with the array direction. The punches within the holder are driven toward the dies by rotating the eccentric cam regardless of moving positions of the holder. Thus, the punching unit can perforate a number of holes greater than the number of punches held within the holder by sequentially moving the holder and by rotating the eccentric cam.

### CROSS REFERENCE TO RELATED APPLICATIONS

This application claims the foreign priority benefit under Title 35, United States Code, §119 (a)-(d) of Japanese Patent Application No. 2010-029421, filed on Feb. 12, 2010 in the Japan Patent Office, the disclosure of which is herein incorporated by reference in its entirety.

### BACKGROUND OF THE INVENTION

1. Field of the Invention

The present invention relates to a punching unit for punching holes through a sheet-like member to be perforated by punches and dies and more specifically to a punching unit suitably attached to a body of an image forming apparatus such as a copier, a printer, a facsimile and their combined machines or to a printing machine.

2. Related Art

Hitherto, as a punching unit for punching a plurality of holes through a sheet-like member to be perforated, there is known a punching unit having a plurality of punches corresponding to a number of holes to be perforated through the member. For instance, while 30 holes are punched in A4 paper and 26 holes are punched in B5 paper to bind in commonly-used binders, the punching unit of the prior art has the same numbers of punches with such numbers of holes.

Still more, while a large force is required to simultaneously drive such large numbers of punches to punch through all holes simultaneously, there is known a structure permitting to reduce such force as disclosed in Japanese Patent Application Laid-open Nos. Hei. 10-15899 and Hei.7-60695 for example.

Among them, Japanese Patent Application Laid-open No. Hei. 10-15899 describes a punching unit having the same number of punches with a number of holes to be perforated and a mechanism for driving the respective punches. As the mechanism for driving the punches, the punching unit adopts a convex punch blade presser whose center part bulges out as compared to its both ends in order to reduce the force required for punching.

Japanese Patent Application Laid-open No. Hei.7-60695 describes a punching unit having a slider that moves along a direction in which punches are arrayed. Each punch is provided with an actuating pin and each actuating pin is engaged with a guide groove provided in the slider. The punching unit sequentially ascends and descends the respective punches based on the engagement of the guide groove and the actuating pins by moving the slider.

However, while JPA Nos. Hei. 10-15899 and Hei.7-60695 described above may be able to reduce the force required for punching, their manufacturing and assembly costs cannot but be increased because they have the same number of punches with the number of holes to be perforated and have large numbers of parts.

Still more, because the same number of holes with the number of punches is punched, it is unable to arbitrarily specify positions to be punched. For instance, although there is a case of punching holes at two distant positions beside the cases of punching 30 holes in A4 paper and 26 holes in B5 paper as described above, the abovementioned prior art punching units are unable to punch such holes by arbitrarily specifying positions to be punched.

It is noted that while the punching unit described in JPA No. H.7-60695 punches holes by moving the slide, more holes are punched corresponding to a moved distance of the slider and it is unable to move the slider to arbitrary positions to punch holes only at such positions for example.

### SUMMARY OF THE INVENTION

Accordingly, in view of the circumstances described above, the present invention aims at providing a punching unit having a structure permitting to reduce a force required for punching, permitting to lessen parts and permitting to punch holes through a member to be perforated at arbitrary positions thereof.

According to a first aspect of the punching unit of the invention, a punching unit for punching a plurality of holes through a sheet-like member to be perforated includes:

a holder holding a punch that reciprocates in an axial direction thereof and a die disposed so as to axially face to the punch;

a moving section for moving the holder to move positions of the punch in an array direction in which the plurality of holes to be perforated are arrayed (referred to simply also as the ‘array direction’ hereinafter);

a driving section for driving the punch toward the die to perforate a hole through the sheet-like member to be perforated, regardless of moving positions of the punch; and

a returning section for returning the punch in the direction opposite from the die; wherein

the holder is moved to move positions of the punch with respect to the sheet-like member to be perforated by the moving section so as to be able to punch a number of holes greater than the number of punch held in the holder through the member to be perforated.

According to a second aspect of the punching unit of the invention, preferably the punching unit further includes a guide hole disposed in the holder to guide the punch;

a guide groove formed either on an outer peripheral surface of the punch or on an inner peripheral surface of the guide hole so as to be aslant with respect to an axial direction of the punch; and

a projection that is provided on the other one of the outer peripheral surface of the punch or of the inner peripheral surface of the guide hole and that engages with the guide groove; and

the punch rotates based on the engagement of the projection with the guide groove in reciprocating in the axial direction.

According to a third aspect of the punching unit of the invention, preferably the driving section has an eccentric cam whose rotary shaft is disposed in parallel with the array direction and which rotates between a position where the cam engages with part of the punch to drive the punch toward the die and a position where the cam does not engage with the punch during when the holder is moved and a driving source for rotating the eccentric cam, and

the returning section has a biasing tool for biasing the punch in the direction opposite from the die.

According to a fourth aspect of the punching unit of the invention, the holder holds the plurality of punches;

the eccentric cam has a plurality of cam portions whose phases of eccentric direction are different from each other; and

the plurality of cam portions engages with parts of the plurality of punches in a state in which the phases are shifted from each other when the eccentric cam rotates.

According to a fifth aspect of the punching unit of the invention, preferably the punching unit further includes:

a rotation detecting section for detecting rotational position of the eccentric cam; and

a control section for controlling the driving source based on detection results of the rotation detecting section.

According to a sixth aspect of the punching unit of the invention, the punching unit further includes a move detecting section for detecting moving positions of the holder, and

the control section controls the moving section based on detection results of the move detecting section.

The other objects and features of the invention will appear in the course of the description of advantageous effects and embodiments thereof which follows.

### ADVANTAGEOUS EFFECTS OF THE INVENTION

According to the first aspect of the punching unit of the invention, the punching unit is capable of punching holes at arbitrary positions by moving the holder holding one or the punch. Still more, because the punching unit allows the number of the punches to be less than the number of holes to be perforated, it becomes possible to reduce a force required for punching holes, to cut number of parts and to cut manufacturing and assembly costs.

According to the second aspect of the punching unit of the invention, it is unnecessary to provide a driving source for rotating the punch separately, so that punching may be carried out efficiently while saving power.

According to the third aspect of the punching unit of the invention, rotational force of the driving source is used to drive the punch toward the die through the intermediary of the eccentric cam and the punch is returned by the biasing tool, so that the structure is simplified and is efficient in terms of its space.

According to the fourth aspect of the punching unit of the invention, the punching unit can operate the plurality of punches while shifting their phases, so that the force required for punching may be reduced. Still more, it becomes possible for the punching unit to drive only a specific punch.

According to the fifth aspect of the punching unit of the invention, it becomes possible to adequately control the rotations of the eccentric cam, so that the punching unit can prevent the eccentric cam from being located at the position where it engages with the punch during when the holder is moved for example and can perform punching works arbitrarily and automatically.

According to the sixth aspect of the punching unit of the invention, it becomes possible to adequately control the moving positions of the holder, so that holes may be perforated automatically at arbitrary positions.

### BRIEF DESCRIPTION OF DRAWINGS

FIG. 1 is a schematic section view showing a structural main part of a punching unit according to a first embodiment of the invention;

FIG. 2 is a schematic front view of the punching unit shown in FIG. 1;

FIG. 3 is a schematic section view showing a structural main part of a punching unit of according to a second embodiment of the invention;

FIG. 4 is a schematic front view of the punching unit shown in FIG. 3; and

FIG. 5 is a partially enlarged view of a punching unit according to a third embodiment of the invention.

### BEST MODES FOR CARRYING OUT THE INVENTION

### First Embodiment

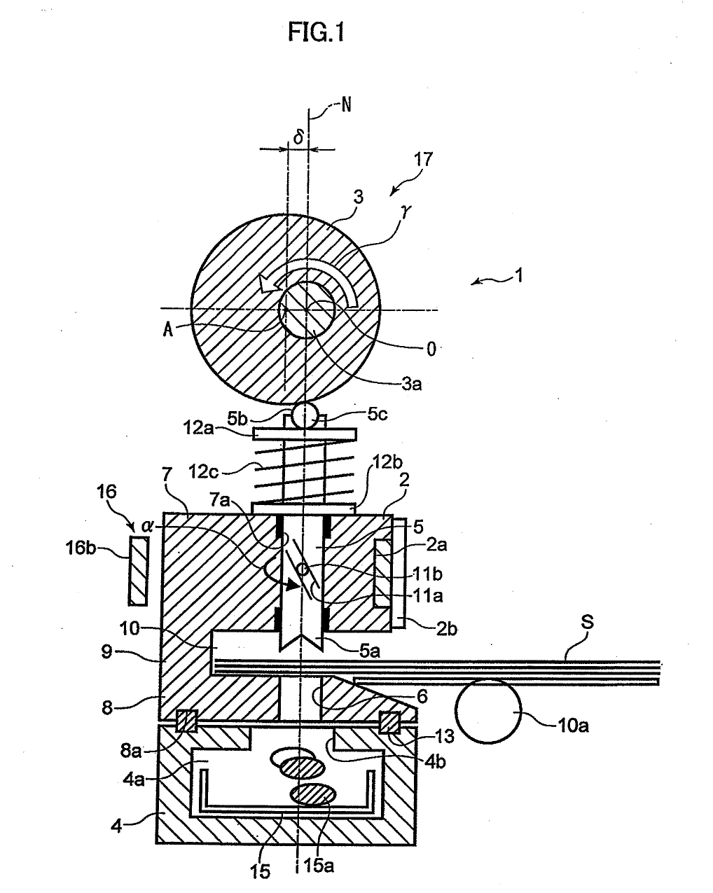

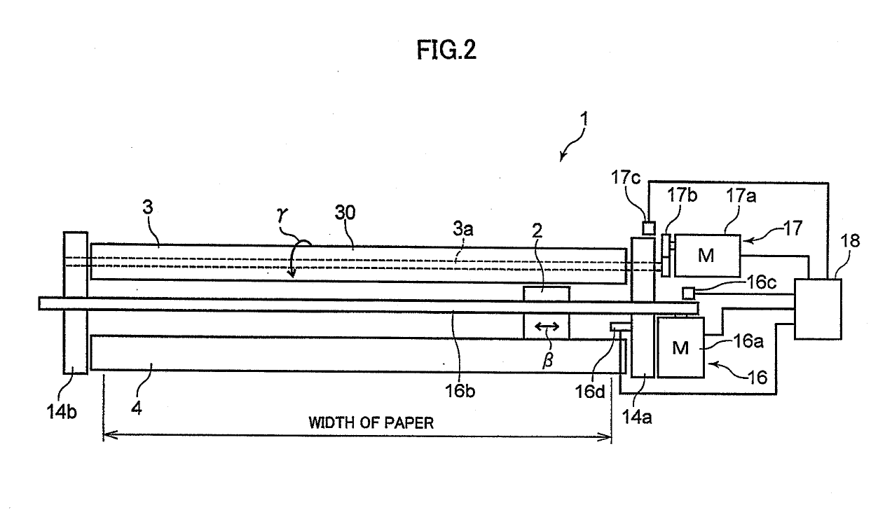

A first embodiment of a punching unit of the invention will be explained with reference to FIGS. 1 and 2. The punching unit 1 has a holder 2 movable in an array direction in which a plurality of holes to be perforated through a sheet-like member S to be punched (in the front and back directions of FIG. 1 or in the lateral direction in FIG. 2) is arrayed, an eccentric cam 3 whose rotary shaft is disposed above the holder 2 in parallel with the array direction of the plurality of holes and a guide beam 4 disposed under the holder 2 in parallel with the array direction.

The holder 2 has one or a plurality of punches 5 and dies 6 of the same number with that of the punches 5 and disposed so as to face to the punches 5 in the axial direction thereof. It is noted that the number of the punches 5 and dies 6 held in the holder is one through three each for example. When the pluralities of punches 5 and dies 6 are held in the holder, they are disposed along the array direction of the plurality of holes to be perforated. A width of the holder 2 in the array direction corresponds to the number of the punches 5 and dies 6. Therefore, the width of the holder 2 in the array direction is considerably smaller than a width of the member to be perforated S.

The holder 2 is composed of a punching holding portion 7 for holding the punch 5, a die holding portion 8 for holding the die 6 and a connecting portion 9 for connecting the punching holding portion 7 with the die holding portion 8.

A clearance 10 having a predetermined distance exists between the punching holding portion 7 and the die holding portion 8. An end of one or of a plurality of members to be perforated S enters within the clearance 10 by being fed by a feed roller 10a or the like.

It is noted that the plurality of members S may be fed by sandwiching and moving the plurality of members S by a pair of rollers from the both sides. Positions of the members S in oblique and widthwise directions are controlled by an obliqueness correcting section not shown before or in advancing into the clearance 10.

By any means, the connecting portion 9 is disposed on the side opposite from the side from which the members S enters. The end of the members S is aligned by butting the edge of thereof to the connecting portion 9. The clearance 10 is opened also at the both sides in the array direction of the holder 2.

The punching holding portion 7 has a number of guide holes 7a formed corresponding to the number of punches 5. The guide hole 7a is formed so as to penetrate through the punching holding portion 7 in the axial direction of the punch 5 to guide axial movements of the punch 5. Because the punch 5 is circular in section in the present embodiment, the guide hole 7a is also formed to be circular in section while having an inner diameter that is slightly larger than an outer diameter of the punch 5.

A guide groove 11a that is formed to be inclined with respect to the axial direction of the punch 5 is formed on the inner peripheral surface of the guide hole 7a. The punch 5 is also provided with a projection 11b that engages with the guide groove 11a on the outer peripheral surface thereof. Thereby, the punch 5 rotates based on the engagement of the guide groove 11a with the projection 11b when it reciprocates in the axial direction. For instance, the punch 5 rotates in a direction of an arrow α in FIG. 1 when the punch 5 descends and rotates in a direction opposite from the arrow α when it ascends.

It is noted that the positional relationship of the guide groove 11a and the projection 11b may be opposite. That is, the projection 11b may be formed on the inner peripheral surface of the guide hole 7a and the guide groove 11a may be formed on the outer peripheral surface of the punch 5. In either case, it is not necessary to separately provide a driving source for rotating the punch 5, so that it is possible to punch holes efficiently while saving power.

A length and an inclination angle of the guide groove 11a are determined corresponding to a moving range of the punch 5. For example, the punch 5 is allowed to rotably move between an ascended position where the punch 5 does not interfere with the members S entering the clearance 10 and a descended position where the punch 5 enters the die 6 and punches a hole through members S. Specifically, the guide groove 11a is formed so as to be able to prevent the punch 5 from ascending further at the ascended position. That is, an end of the guide groove 11a is engaged with the projection 11b to prevent the punch 5 from ascending further and engaging with the eccentric cam 3 as described later.

The punch 5 which rotably reciprocates within the guide hole 7a as described above has a blade edge portion 5a at an edge thereof (lower end portion in FIG. 1) and a spherical surface portion 5b at a base end portion (upper end portion in FIG. 1), respectively. The blade edge portion 5a is notched into a shape of V to perforate a hole at predetermined position of the members S. The spherical surface portion 5b is formed by embedding a ball 5c so that part thereof is exposed to a base end surface of the punch 5 to engage with the eccentric cam 3 described later. It is noted that the spherical surface portion 5b may be also provided by forming the base end surface of the punch 5 into a spherical shape.

The length of the punch 5 is fully longer than that of the guide hole 7a so that even if the punch 5 is located at the descended position, the base end side thereof (upper side in FIG. 1) projects out of the guide hole 7a.

The punch 5 is provided with a flange 12a at the base end portion thereof. The punching holding portion 7 is also provided with a flange 12b fixed at an upper surface thereof and around the guide hole 7a. Then, a spring 12c, i.e., biasing tool, is interposed between the both flanges 12a and 12b while being elastically compressed. That is, this spring 12c is disposed around the part of the punch 5 projecting out of the guide hole 7a at the base end side of the punch 5. Accordingly, the punch 5 is biased toward the upper side in FIG. 1 by elastic restorative force of the spring 12c. This structure composes a returning section for returning the punch 5 in the direction opposite from the die 6, i.e., toward the upper side in FIG. 1.

The die 6 is formed circularly in section and is disposed concentrically with the punch 5 so as to penetrate through the die holding portion 8. Because the die holding portion 8 is fixed with the punching holding portion 7 by the connecting portion 9, the concentricity of the punch 5 and the die 6 is maintained regardless of the movement of the holder 2 described later. Because the holder 2 thus holds the same numbers of punches 5 and dies 6, center axes of the punch 5 and the die 6 may be readily aligned, allowing holes having a high-quality shape to be perforated.

The die holding portion 8 is also provided, at an under surface thereof, with rail grooves 8a that fit with rails 13 disposed at an upper surface of a guide beam 4 described below in the array direction. The rail grooves 8a are formed at the under surface of the die holding portion 8 so as to be opened at both ends of the array direction.

The guide beam 4 is disposed in parallel with the array direction and is slightly larger than a width of the members S (width of paper, see FIG. 2). As shown in FIG. 2, the guide beam 4 is fixed to frames 14a and 14b disposed on the both sides in the array direction of the guide beam 4. The guide beam 4 is provided, at the upper end surface, with the two rails 13 in parallel with each other across the whole punching range in the array direction.

The guide beam 4 is also provided, therein, with a space 4a formed along the array direction. The space 4a has an opening 4b that opens between the two rails 13. The opening 4b faces to an opening located under the die 6 and guides chips 15a discharged out of the die 6 to the space 4a. A chip tray 15 is placed within the space 4a to accumulate the chips 15a discharged to the space 4a. The chip tray 15 may be taken out of the guide beam 4 so that the chips 15a accumulated in the chip tray 15 may be disposed.

While the holder 2 is movable along the rail 13, the punching unit of the present embodiment has a moving section 16 for moving the holder 2. As shown in FIG. 2, the moving section 16 includes a motor 16a fixed to the frame 14a and a belt 16b rotated and driven by the motor 16a. The belt 16b is an endless belt and is suspended around a driving pulley fixed to a rotary shaft of the motor 16a and a driven pulley rotably supported by the opposite-side frame 14b so that the belt 16b between the driving and driven pulleys becomes parallel with the array direction. It is noted that a decelerating mechanism may be provided between the driving pulley and the rotary shaft of the motor 16a.

Part of the belt 16b is then fixed with the holder 2. In the case of the present embodiment, the part of the belt 16b is fixed on a side surface of the punching holding portion 7 opposite from the connecting portion 9 as shown in FIG. 1. Specifically, the part of the belt 16b is disposed within a concave portion 2a formed on the side surface of the holder 2 and is fixed to part of the holder 2 by means of screws or the like so as to cover by a presser plate 2b. Thereby, the part of the belt 16b is fixed to the holder 2 by being sandwiched by the concave portion 2a and the presser plate 2b.

It is noted that the part of the belt 16b may be fixed to the holder 2 by means of other means such as adhesive. The position where the belt is fixed may be also altered. In either case, the holder 2 which is fixed to the part of the belt 16b is moved in the directions of an arrow β as shown in FIG. 2 by rotating the belt 16b by driving the motor 16a.

Furthermore, according to the present embodiment, the punching unit has a rotation detecting sensor 16c, i.e., a move detecting section, for detecting moving positions of the holder 2. The rotation detecting sensor 16c is composed of a tonewheel whose circumferential characteristics change by rotating together with the rotary shaft of the motor 16a and a detecting portion for detecting the characteristic changes of the tonewheel. Specifically, a notch or a through hole is formed at one place in the circumferential direction of the disc-like tonewheel so as to detect light passing through the notch or the through hole. Then, the rotation detecting sensor 16c detects a number of rotations of the rotary shaft of the motor 16a. It is then possible to detect the moving position of the holder 2 if the number of rotations of the rotary shaft is found because a moving distance of the belt 16b may be calculated from an outer diameter of the driving pulley (by considering also a rate of deceleration when the deceleration mechanism is provided). It is noted that the structure of the rotation detecting sensor 16c is not limited to what described above and any conventionally known rotation detecting sensor may be used.

The punching unit of the present embodiment is also provided with a home position sensor 16d for detecting home position of the holder 2 in contact or in non-contact with the holder 2 at the frame 14a. That is, the home position sensor 16d detects the holder 2 when the holder 2 is located at the right end portion of the holder moving range in FIG. 2, i.e., the position where the holder 2 starts punching. It is noted that while the move detecting section is constructed as described above in the present embodiment, the move detecting section may be constructed in other ways so long as the move detecting section can detect the move of the holder 2. For instance, it is also possible to provide sensors at a plurality of places in the array direction of the guide beam 4 and to detect the moving positions of the holder 2 by the plurality of sensors.

Positions where the plurality of sensors is provided are determined corresponding to positions of holes to be perforated and a number of punches 5 held by the holder 2. For instance, it is conceivable to dispose ten sensors at equal intervals if a number of holes to be perforated is 30 and the number of the punches 5 held in the holder 2 is three.

The motor 16a described above is controlled by a control section 18. It is noted that this control section 18 may be identical with a control section of an apparatus such as a printer into which the punching unit 1 is incorporated. In other words, it is possible to arrange so as to control the operations of the punching unit 1, i.e., the motor 16a and others, by the control section provided in the apparatus such as a printer. In any case, the control section 18 drives the motor 16a by receiving a punching command and based on detected results of the rotation detecting sensor 16c and the home position sensor 16d.

The eccentric cam 3 is formed to be circular in section and so that a center A of an outer circumferential surface thereof is eccentric with respect to a center of rotation O by a predetermined distance δ. The eccentric cam 3 is disposed in parallel with the array direction and across the whole holder moving range in the array direction. Therefore, the both ends of the rotary shaft 3a disposed in parallel with the array direction are rotably supported respectively by the frames 14a and 14b.

The eccentric cam 3 is disposed so that the center of rotation O comes right above a central axis N of the punch 5. Thereby, a rotary force of the eccentric cam 3 may be transformed efficiently into a force for driving the punch 5 and the rotary force may be transmitted to the punch 5 stably even if the eccentric cam 3 rotates in either directions.

The rotary shaft 3a is rotated and driven by the motor 17a, i.e., a driving source, through the intermediary of the decelerating mechanism 17b. That is, the decelerating mechanism 17b transmits rotations of the motor 17a to the rotary shaft 3a by engaging a small gear fixed to the rotary shaft of the motor 17a and having a less number of teeth with a large gear fixed to an end of the rotary shaft 3a of the eccentric cam 3 and having a large number of teeth. It is noted that the decelerating mechanism 17b may be cut. The eccentric cam 3, the rotary shaft 3a, the motor 17a and the decelerating mechanism 17b compose the driving section 17 in the present embodiment.

The eccentric cam 3 as described above is rotated by the motor 17a in a direction of an arrow γ for example as shown in FIGS. 1 and 2 to engage an outer peripheral surface thereof with the spherical surface portion 5b, i.e., part of the punch 5, and to drive the punch 5 toward the die 6 (downward in FIG. 1). The eccentric cam 3 is disengaged from the spherical surface portion 5b when the eccentric cam 3 is rotated further. When the eccentric cam 3 is disengaged from the spherical surface portion 5b, the eccentric cam 3 does not engage with the punch 5 during when the holder 2 is moved as described above. That is, the eccentric cam 3 rotates between the position where the punch 5 is struck toward the die 6 and the position where the eccentric cam 3 does not engage with the punch 5 during when the holder 2 is moved.

To that end, the outer diameter and the eccentric distance δ of the eccentric cam 3 are adequately controlled so that the punch 5 is struck to the descended position described above within the die 6 by engaging the eccentric cam 3 with the spherical surface portion 5b when the eccentric cam 3 is rotated and so that the spherical surface portion 5b is disengaged from the eccentric cam 3 even when the punch 5 is located at the ascended position described above. Still more, because the eccentric cam 3 is disposed across the whole holder moving range in the array direction as described above, it is possible to move the punch 5 toward the die 6 to punch a hole through the members S regardless of the moving positions of the punch 5.

Furthermore, according to the present embodiment, the punching unit has a rotation detecting sensor 17c, i.e., a rotation detecting section, for detecting rotational positions of the eccentric cam 3. The rotation detecting sensor 17c is composed of a tonewheel which is rotated together with the rotary shaft 3a of the eccentric cam 3 and whose circumferential characteristics change and a detecting portion for detecting the characteristic changes of the tonewheel.

Specifically, a notch or a through hole is formed at one or plurality of places in the circumferential direction of the disc-like tonewheel so as to detect light passing through the notch or the through hole. When the notch or the through hole is provided at one place and the light is detected, it is possible to detect that the eccentric cam 3 has rotated once and a phase of the eccentric cam 3 corresponding to the notch or the through hole. When the notch or the through hole is provided at the plurality of places, it becomes possible to detect a rotational angle of the eccentric cam 3 corresponding to the number of the notches or the through holes.

In the present embodiment, all of the punches 5 within the holder 2 move when the eccentric cam 3 rotates once, so that the notch or the through hole may be one. However, it is preferable to arrange the notch or the through hole of the tonewheel so as to be able to detect the position where the eccentric cam 3 does not engage with the punch 5. This arrangement permits to prevent the eccentric cam 3 from coming to the position where it engages with the punch 5 during when the holder 2 is moved. It is noted that the structure of the rotation detecting sensor 17c is not limited to what described above and any conventional devices for detecting rotations may be used in the invention. The motor 17a is driven by the control section 18 based on detected results of the rotation detecting sensor 17c described above.

The punching unit 1 having the structure as described above operates as follows. That is, an end of the member to be perforated S enters the clearance 10 of the holder 2. In this state, the holder 2 is located at the home position. Then, based on a number and positions of holes to be perforated and a size of the members S, the control section 18 operates the motor 16a and the motor 17a.

Specifically, the control section 18 moves the holder 2 by the motor 16a to the position where the holes are to be perforated. Next, the control section 18 operates the motor 17a to rotate the eccentric cam 3 and to punch the same number of holes with that of the punches 5 within the holder 2 at the predetermined position of the members S by the punches 5 and the dies 6.

After completing punching at the predetermined position, the control section 18 rotates the eccentric cam 3 to the position where it does not engage with the punches 5. The punches 5 return to the ascended position by the elastic force of the spring 12c.

Then, the control section 18 operates the motor 16a again to move the holder 2 to the next position where holes are to be perforated and drives the motor 17a to punch holes in the same manner. Thus, the punching unit 1 of the present embodiment is capable of punching a number of holes greater than the number of punches 5 held in the holder 2 by repeating such operations by a predetermined number of times.

If the number of punch 5 held in the holder 2 is one and the number of holes to be perforated through the members S is a few holes such as two, three or four holes for example, the holder 2 is moved to positions corresponding to the respective holes and the eccentric cam 3 is rotated once per hole. Thereby, it becomes possible to perforate holes corresponding to conventional binders of two, three or four holes.

When the number of punches 5 held in the holder 2 is two, it becomes possible to perforate either 26 or 30 holes. Still more, if the number of punches 5 held in the holder 2 is three or more, it becomes possible to perforate a large number of holes by moving the holder 2 with a less number of times.

As described above, according to the present embodiment, it becomes possible to perforate holes at arbitrary positions by moving the holder 2 holding one or the plurality of punches 5. Still more, because the number of punches 5 may be less than the number of holes to be perforated, it becomes possible to reduce the force required for punching, to lessen numbers of parts and to cut manufacturing and assembly costs.

Still more, because the eccentric cam 3 is used as the means for driving the punches 5 and the spring 12c is used as the returning section in the present embodiment, the structure may be simplified and may be efficient in terms of its space. For instance, although it is conceivable of driving the punches by the mechanism that ascends and descends as described in Japanese Patent Application Laid-open No. Hei. 10-15899, the ascending and descending mechanism is complicated and is bulky. In contrast to that, it is just necessary to provide the mechanism of rotating the eccentric cam 3 and the structure can be thus simplified and can be not bulky if the punches are struck and returned by means of the eccentric cam 3 and the spring 12c like the present embodiment.

Still more, the moving positions of the holder 2 can be adequately controlled by detecting the positions by the rotation detecting sensor 16c and the home position sensor 16d in the present embodiment. The rotation of the eccentric cam 3 can be also adequately controlled by detecting the rotations by the rotation detecting sensor 17c. Accordingly, the punching works may be carried out corresponding to the positions and the number of holes arbitrarily. That is, the control section 18 can operate the respective motors 16a and 17a corresponding to the positions and number of holes to be perforated based on the detected results of the respective sensors 16c, 16d and 17c. Thus, the punching works corresponding to the desired positions and number of holes of the members S may be carried out automatically.

### Second Embodiment

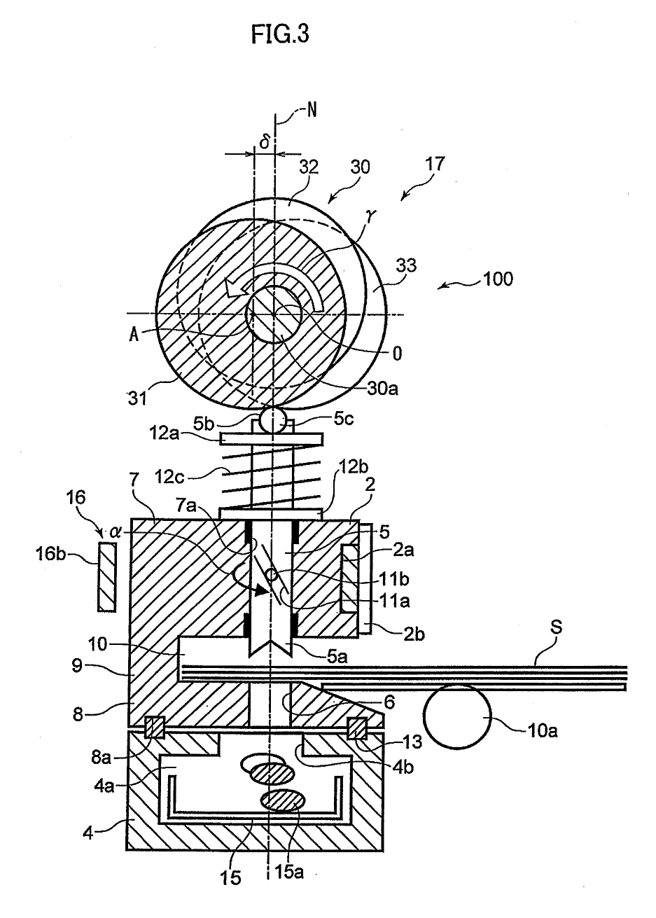

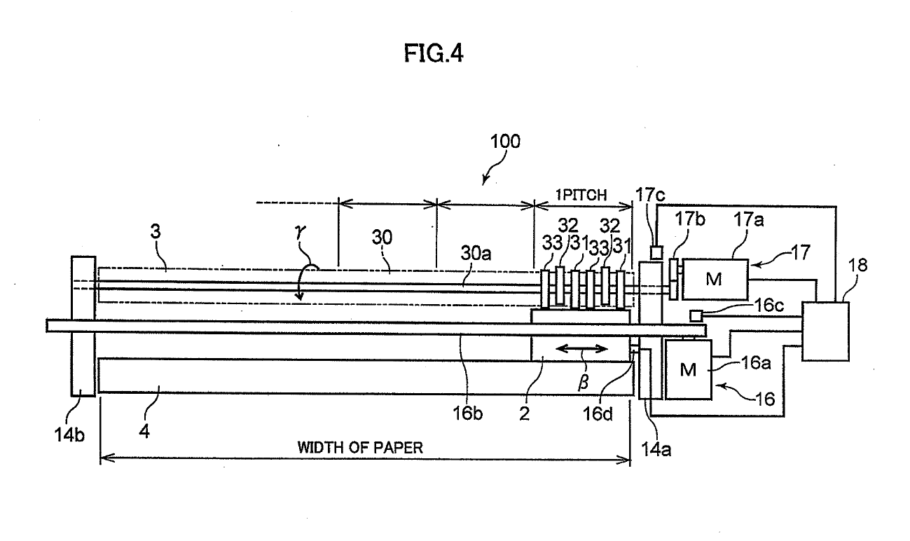

A second embodiment of the punching unit of the invention will be explained with reference to FIGS. 3 and 4. It is noted that the punching unit 100 of the present embodiment is the same with the punching unit of the first embodiment described above except of the structure of the eccentric cam, so that the same or corresponding parts will be denoted by the same reference numerals, an overlapped explanation will be omitted or simplified and the following explanation will be made centering on the part different from the first embodiment.

In the present embodiment, a plurality (six in the case of the drawing) punches 5 is disposed within the holder 2. Still more, an eccentric cam 30 has a plurality of cam portions 31, 32 and 33 whose phases in terms of eccentric direction are different from each other. These cam portions 31, 32 and 33 are composed of three types of discs which are disposed along a rotary shaft 30a at the same intervals with the plurality of punches 5 and whose phases in terms of the eccentric direction are shifted by 90° each. A diameter and an eccentric distance δ of the three types of the cam portions 31, 32 and 33 are the same.

The ascended position where the punches 5 do not engage with the member to be perforated S entering the clearance 10 and where all of the cam portions 31, 32 and 33 of the eccentric cam 30 do not engage with the punches 5 is supposed here to be 0°. Then, the eccentric cam 30 is adapted so that the cam portions 31, 32 and 33 sequentially engage with and drive the respective corresponding punches 5 every time when the eccentric cam 30 is rotated by 90° each in the direction of the arrow γ as shown in FIGS. 3 and 4 from this position. That is, the plurality of cam portions 31, 32 and 33 engages with part of the plurality of punches 5 while shifting their respective phases as the eccentric cam 30 rotates.

While an order of the array of the three kinds of the cam portions 31, 32 and 33 described above may be set arbitrarily, they are arrayed in an order of the cam portion 31, the cam portion 32 and the cam portion 33 from the right end and two each cam portions are arrayed in a range corresponding to one pitch of the holder 2 in the case of the structure shown in FIG. 4.

Then, when the eccentric cam 30 rotates, the two cam portions 31 engage with the corresponding punches 5, the next two cam portions 32 engage with the corresponding punches 5 and finally, the two cam portions 33 engage with the corresponding punches 5. Punching is carried out sequentially at the positions corresponding to the respective punches 5.

Although not shown, such array of the cam portions in the range corresponding to one pitch of the holder 2 is repeatedly arrayed in the axial direction of the eccentric cam 30. Accordingly, when the holder 2 moves by one pitch and the eccentric cam 30 rotates, the cam portions 31, 32 and 33 engage respectively with the corresponding punches 5 to perforate holes in the same order as described above.

That is, according to the present embodiment, the punching works may be carried out per each three groups. For example, when the first group is defined to be the cam portion 31, the second group to be the cam portion 32 and the third group to be the cam portion 33, punching may be carried out by the punches 5 by the cam portion of either group corresponding to the rotational angle of the eccentric cam 30. Still more, the eccentric cam 30 moves the holder 2 with a rotational angle by which all of the cam portions do not engage with the punches 5 to prevent the eccentric cam 30 from engaging with the punch 5.

It is noted that although the three groups are composed of two cam portions, respectively, in the region corresponding to one pitch of the holder 2, each group may be also composed of one cam portion or three or more cam portions. If each group is composed of one cam portion for example, three punches 5 are driven when the eccentric cam 30 rotates once, if each group is composed of two cam portions, six punches 5 are driven and if each group is composed of three cam portions, nine punches 5 are driven in the same manner.

Still more, when it is desirable to carry out punching sequentially only at the position of the cam portion 31 in the first group, the eccentric cam 30 is rotated from the position of 0° in the direction of arrow γ in FIG. 3 by 90° and is then rotated in the reverse direction by 90°. Meanwhile, when it is desirable to punch sequentially only at the position of the cam portion 33 in the third group, the eccentric cam 30 is rotated from the position of 0° in the direction opposite from the direction of the arrow γ in FIG. 3 and is then rotated in the reverse direction again from that position, i.e., in the direction of the arrow γ in FIG. 3. When it is desirable to punch also at the position of the cam portion 32 of the second group in addition to the first and third groups, the eccentric cam 30 is rotated in the same direction further by 90° after punching by the first or third group and is then rotated by 180° in the reverse direction. In this case, while the cam portion 31 or the cam portion 33 of the first or the third group engages with the corresponding punch 5 during the reverse rotation, this corresponding punch 5 only passes through an already perforated hole.

Still more, the rotation detecting sensor 17c, i.e., the rotation detecting section for detecting rotational positions of the eccentric cam 30, is composed of a tonewheel that rotates together with the rotary shaft 30a of the eccentric cam 30 for example and whose circumferential characteristic changes and a detecting section for detecting the characteristic changes of the tonewheel in the present embodiment. The notches or the through holes to be formed at a plurality of places in the circumferential direction of the disc-like tonewheel are formed at corresponding parts of the cam portions 31, 32 and 33 in the present embodiment. Thereby, it becomes possible to detect that the cam portions 31, 32 and 33 have rotated to the positions where they engage with the corresponding punches 5 and to the positions where they do not engage with the punches.

According to the present embodiment arranged described above, the plurality of punches 5 can be struck while shifting their phases, so that the force required for punching can be reduced. That is, the cam portions of either group engage sequentially with the corresponding punches 5 by rotating the eccentric cam 30 by 90° each. Accordingly, the force required for the respective engagements can be reduced as compared to the case of engaging with all punches 5 within the holder 2 at once. Still more, all of the punches 5 within the holder 2 can be struck with a small force when the eccentric cam 30 rotates once, so that punching can be carried out without dropping the efficiency.

As a result, it becomes possible to cut output power of the motor 17a that drives the eccentric cam 30 and to cut costs by saving power and by downsizing the motor.

Still more, it becomes possible to drive only specific punches 5. That is, punching may be carried out by selecting any one of only the first group, only the third group and only the first or the third group and the second group.

Still more, the phase differences and the number of groups of the respective cam portions described above may be arbitrarily set. The relationship of disposition of the cam portions within one pitch of the holder 2 may be also arbitrarily set. For example, the number of groups may be four or more and the phase differences may be angles corresponding to that number. However, a phase in which all of the cam portions do not engage with the punches 5 is provided at the ascended position of the punches 5 in any case.

Furthermore, at least one group among the plurality of groups is composed of one cam portion and the phase of this cam portion is set so as to be able to drive only this one cam portion. Thereby, when only two holes distant by a predetermined distance are to be perforated, it becomes possible to punch the first hole by one cam portion and to punch the second hole by the cam portion by moving the holder 2 to the next hole to be perforated.

It is also possible to efficiently punch a large number of holes, e.g., 30 holes and 20 holes, with this arrangement by driving all or part of the cam portions further.

### Third Embodiment

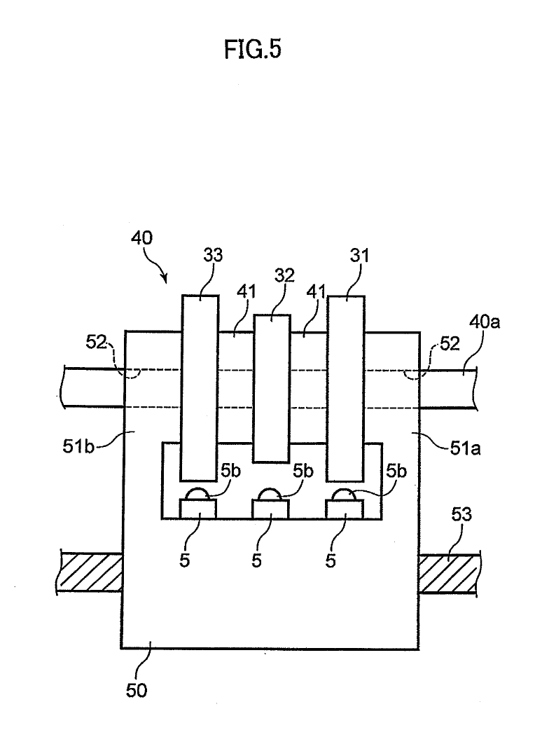

A third embodiment of the punching unit of the invention will be explained with reference to FIG. 5. It is noted that FIG. 5 corresponds to a drawing in which part of FIG. 4 is enlarged. Still more, the punching unit of the present embodiment is the same with the punching unit of the second embodiment described above except of the structure of moving the eccentric cam in a body with the holder, so that the same or corresponding parts will be denoted by the same reference numerals, an overlapped explanation will be omitted or simplified and the following explanation will be made centering on the part different from the second embodiment.

The present embodiment is adapted so that cam portions 31, 32 and 33 composing an eccentric cam 40 are movable together with a holder 50 holding the punches 5. To that end, the cam portions 31, 32 and 33 disposed to a rotary shaft 40a operated by a motor not shown in a state in which each of their phase is restricted by spline-engagement are sandwiched by a pair of arms 51a and 51b of the holder 50. These arms 51a and 51b have, respectively, a cylindrical surface 52 having an inner diameter slightly larger than a circumscribed circle of the rotary shaft 40a having external spline. This cylindrical surface 52 is loosely fitted with the rotary shaft 40a so as to prevent the cylindrical surface 52 from rotating together with the rotary shaft 40a while being supported by the rotary shaft 40a.

Meanwhile, the cam portions 31, 32 and 33 are arranged while interposing spacers 41 between them so that their intervals are equalized with intervals of the punches 5. Still more, because the cam portions 31, 32 and 33 (as well as the spacers 41 as necessary) are spline-engaged with the rotary shaft 40a as described above, they rotate together with the rotary shaft 40a. Further, because the cam portions 31, 32 and 33 are sandwiched between the arms 51a and 51b of the holder 50, they move together with the holder 50 along the rotary shaft 40a.

It is noted that a means for moving the holder 50 is composed of a feed screw mechanism in the present embodiment. That is, a male screw 53 which is rotated by a motor not shown is disposed in the array direction of the plurality of holes to be perforated and part thereof is screwed into a female screw portion formed in the holder 50. Then, the holder 50 is moved in the array direction by the screw mechanism of the male screw 53 and the female screw portion when the male screw 53 is rotated.

Still more, because the holder 50 moves by being supported by the rotary shaft 40a, it is possible to eliminate the rails 13 as shown in FIGS. 1 and 3 in the present embodiment. However, the rails 13 may be still provided to enhance stability of the operation.

Furthermore, because the cam portions 31, 32 and 33 move together with the holder 50 in the present embodiment, either cam portion may be kept engaged with the spherical surface portion 5b of the punch 5 at the ascended position of the punch 5.

Although the holder 50 is prone to be rotated following the rotation of the rotary shaft 40a because the arms 51a and 51b thereof are supported to the rotary shaft 40a, it is possible to prevent the holder 50 from being rotated by engaging the male screw 53 with the female screw portion.

It is noted that the means for moving the holder 50 may be constructed by using the belts as described in the first and second embodiments also in the present embodiment, it is possible to prevent the holder 50 from rotating by providing the rails 13 in such a case.

Because the cam portions 31, 32 and 33 composing the eccentric cam 40 are movable together with the holder 50 in the present embodiment as described above, it is unnecessary to dispose the cam portions 31, 32 and 33 in the whole holder moving range in the array direction like the second embodiment described above and thus the cost may be cut. It is noted that the number and phases of the cam portions 31, 32 and 33 may be arbitrarily set in the same manner with the second embodiment.

It is noted that although the holder is moved by driving the belt or the male screw in the embodiments described above, the holder may be moved by other mechanisms. It is also possible to adopt the feed screw mechanism in the first and second embodiments. Still more, the structure of using the eccentric cam as the driving section for driving the punches has been described in the embodiments described above, the driving section may be constructed by other mechanisms such as a mechanism that moves up and down above the punches 5.

It is also possible to arrange so that the chip tray moves together with the holder. That is, the part having the chip tray may be fixed to the holder so that they can move on the rails disposed between the frames 14a and 14b.

What is claimed is:

1. A punching unit for punching a plurality of holes through a sheet-like member to be perforated, comprising:
a holder holding a punch that reciprocates in an axial direction thereof and a die disposed so as to axially face to said punch;
a moving section for moving said holder to move position of said punch in an array direction in which the plurality of holes to be perforated are arrayed;
a driving section for driving said punch toward said die to perforate a hole through the sheet-like member to be perforated regardless of moving positions of said punch; and
a returning section for returning said punch in the direction opposite from said die;
said holder being moved to move positions of said punch with respect to the sheet-like member to be perforated by said moving section so as to be able to punch a number of holes greater than the number of said punch held in said holder through the sheet-like member to be perforated.

2. The punching unit according to claim 1, further comprising:
a guide hole disposed in said holder to guide said punch;
a guide groove formed either on an outer peripheral surface of said punch or on an inner peripheral surface of said guide hole so as to be aslant with respect to the axial direction of said punch; and
a projection that is provided on the other one of said outer peripheral surface of said punch or of said inner peripheral surface of said guide hole and that engages with said guide groove;
said punch rotating based on the engagement of said projection with said guide groove in reciprocating in the axial direction.

3. The punching unit according to claim 1, wherein said driving section has an eccentric cam whose rotary shaft is disposed in parallel with the array direction and which rotates between a position where said cam engages with part of said punch to drive said punch toward said die and a position where said cam does not engage with said punch during when said holder is moved, and a driving source for rotating said eccentric cam; and
said returning section has a biasing tool for biasing said punch in the direction opposite from said die.

4. The punching unit according to claim 3, wherein said holder holds a plurality of said punches;
said eccentric cam has a plurality of cam portions whose phases of eccentric direction are different from each other; and
said plurality of cam portions engages with part of said plurality of punches in a state in which the phases are shifted from each other when said eccentric cam rotates.

5. The punching unit according to claim 3, further comprising:
a rotation detecting section for detecting rotational positions of said eccentric cam; and
a control section for controlling said driving source based on detection results of said rotation detecting section.

6. The punching unit according to claim 4, further comprising:
a rotation detecting section for detecting rotational positions of said eccentric cam; and
a control section for controlling said driving source based on detection results of said rotation detecting section.

7. The punching unit according to claim 5, further comprising:
a move detecting section for detecting moving positions of said holder;
wherein said control section controls said moving section based on detection results of said move detecting section.

8. The punching unit according to claim 6, further comprising:
a move detecting section for detecting moving positions of said holder;
wherein said control section controls said moving section based on detection results of said move detecting section.

9. A punching unit for punching a plurality of holes through a sheet-like member to be perforated, comprising:
a holder holding a punch that reciprocates in an axial direction thereof and a die disposed so as to axially face to said punch;
a moving section for moving said holder to move positions of said punch in an array direction in which the plurality of holes to be perforated are arrayed;
a driving section for driving said punch toward said die to perforate a hole through the sheet-like member to be perforated regardless of moving positions of said punch;
a returning section for returning said punch in the direction opposite from said die;
a guide hole disposed in said holder to guide said punch;
a guide groove formed either on an outer peripheral surface of said punch or on an inner peripheral surface of said guide hole so as to be aslant with respect to the axial direction of said punch;
a projection that is provided on the other one of said outer peripheral surface of said punch or of said inner peripheral surface of said guide hole and that engages with said guide groove;
said punch rotating based on the engagement of said projection with said guide groove in reciprocating in the axial direction;
said driving section having an eccentric cam whose rotary shaft is disposed in parallel with the array direction and which rotates between a position where said cam engages with part of said punch to drive said punch toward said die and a position where said cam does not engage with said punch during when said holder is moved, and a driving source which is provided in said driving section to rotate said eccentric cam;
said returning section having a biasing tool provided in said returning section to bias said punch in the direction opposite from said die;
a rotation detecting section for detecting rotational positions of said eccentric cam;
a control section for controlling said driving source based on detection results of said rotation detecting section; and
a move detecting section for detecting moving positions of said holder;
said control section controlling said moving section based on detection results of said move detecting section; and
said holder being moved to move positions of said punch with respect to the member to be perforated by said moving section so as to be able to punch a number of holes greater than the number of said punch held in said holder through the member to be perforated.

10. The punching unit according to claim 9, wherein said eccentric cam has a plurality of cam portions whose phases of eccentric direction are different from each other; and
said plurality of cam portions engages with part of said plurality of punches in a state in which the phases are shifted from each other when said eccentric cam rotates.

11. A punching method for punching a plurality of holes through a sheet-like member to be perforated, comprising steps of:
holding a punch that reciprocates in an axial direction thereof and a die disposed so as to axially face to said punch in a holder;
moving said holder to move position of said punch in an array direction in which the plurality of holes to be perforated are arrayed;
driving said punch toward said die to perforate a hole through the member to be perforated regardless of moving positions of said punch; and
returning said punch in the direction opposite from said die;
said holder being moved to move positions of said punch with respect to the member to be perforated so as to be able to punch a number of holes greater than the number of said punch held in said holder through the member to be perforated.
